(19) United States
(12) Patent Application Publication
(10) Pub. No.: US 2018/0278786 A1
(43) Pub. Date: Sep. 27, 2018

(54) CASE AND APPARATUS FOR IMAGE FORMATION

(71) Applicants: KABUSHIKI KAISHA TOSHIBA, Tokyo (JP); TOSHIBA TEC KABUSHIKI KAISHA, Tokyo (JP)

(72) Inventor: Masao Yamaguchi, Katsushika Tokyo (JP)

(21) Appl. No.: 15/467,131

(22) Filed: Mar. 23, 2017

(51) Int. Cl. H04N 1/00; G10K 11/172; G10K 11/04

(52) U.S. Cl. CPC H04N 1/00976; G10K 11/04; G10K 11/172

(57) ABSTRACT

A case of an exemplary embodiment accommodates an apparatus including a movable part and includes a case base, a first member, and a second member. The first member includes a first surface and a second surface opposing each other, and is provided with a hole formed by opening at least a side of the second surface, among a side of the first surface and the side of the second surface. The second member includes a third surface and a fourth surface opposing each other, and is provided with a communicating hole formed by opening both a side of the third surface and a side of the fourth surface. The first member is provided such that the first surface is in contact with a wall surface of a side of the apparatus of the case base.

### FIELD

Embodiments described herein relate generally to a case and an apparatus for image formation.

### BACKGROUND

A movable part becomes a noise generation source in an apparatus having the movable part such as a motor. In such an apparatus, a sound absorbing material is included in order to reduce noise. However, for a frequency of a sound capable of being absorbed by a sound absorbing material, the sound absorbing effect for a sound of a frequency within a specific frequency band is high while the sound absorbing effect for a sound of other frequencies is low.

In FIG. 1, frequency-sound absorption characteristics of a urethane foam as an example of a sound absorbing material are illustrated. As illustrated in FIG. 1, the urethane foam exhibits sound absorption characteristics in which sound absorbing effect of a frequency band centered at approximately 2000 Hz is high. For that reason, sound absorbing effect for a sound of a frequency band other than the frequency band, which is in the vicinity of approximately 2000 Hz, is low in the urethane foam. However, there is an apparatus which generates sounds of various frequencies among apparatuses having movable parts. In such an apparatus, even when a sound absorbing material is utilized, it is unable to sufficiently reduce noise other than a sound of a frequency band for which sound absorbing effect is high.

Sound absorbing materials exhibit frequency-sound absorption characteristics which are different for each type of sound absorbing material and thus, even when it is intended to make an apparatus generating a sound of a frequency within a narrow frequency range silent, it is needed to prepare a type of sound absorbing material, which has a high sound absorbing effect of a frequency band, according to the frequency, and thus time and labor are needed.

### DESCRIPTION OF THE DRAWINGS

FIG. 1 illustrates a graph of frequency-sound absorption characteristics of urethane foam.

FIG. 2 illustrates a schematic diagram of a configuration of main units of an image forming apparatus and a finisher according to a first exemplary embodiment and a second exemplary embodiment.

FIG. 3 illustrates a schematic cross sectional view of a case according to the first exemplary embodiment.

FIG. 4 illustrates an exploded perspective view of the case according to the first exemplary embodiment.

FIG. 5 illustrates a schematic cross sectional view of a case according to a second exemplary embodiment.

FIG. 6 illustrates an exploded perspective view of the case according to the second exemplary embodiment.

FIG. 7 illustrates a schematic diagram of a space formed by a hole and a communicating hole.

FIG. 8 illustrates another schematic diagram of a space formed by a hole and a communicating hole.

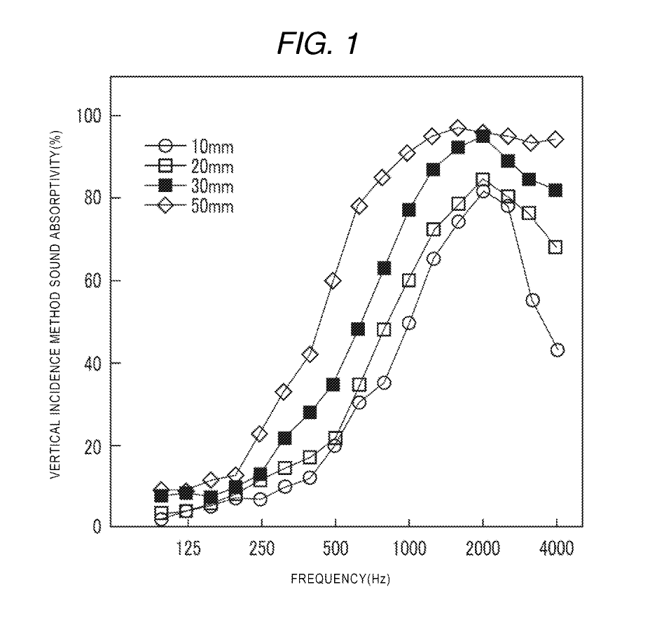

### DETAILED DESCRIPTION

A problem to be solved by the present disclosure is to provide a case which makes a sound of an arbitrary frequency silent and an apparatus for image formation including the case.

A case of an exemplary embodiment is able to accommodate an apparatus including a movable part and includes a case base, a first member, and a second member. The first member includes a first surface and a second surface opposing each other and is provided with a hole formed by opening at least a side of the second surface, among a side of the first surface and the side of the second surface. The second member includes a third surface and a fourth surface opposing each other and is provided with a communicating hole formed by opening both a side of the third surface and a side of the fourth surface. The first member is provided such that the first surface is in contact with a wall surface of a side of the apparatus of the case base. The second member is provided such that the third surface is in contact with the second surface of the first member. The hole and the communicating hole are connected to each other.

In the following, description will be made on an image forming apparatus and a finisher according to several exemplary embodiments with reference to the drawings. In respective drawings used for explaining the present exemplary embodiments of the present disclosure, a scale of each member may be appropriately modified in order to allow each member to be represented in a recognizable size.

### First Exemplary Embodiment

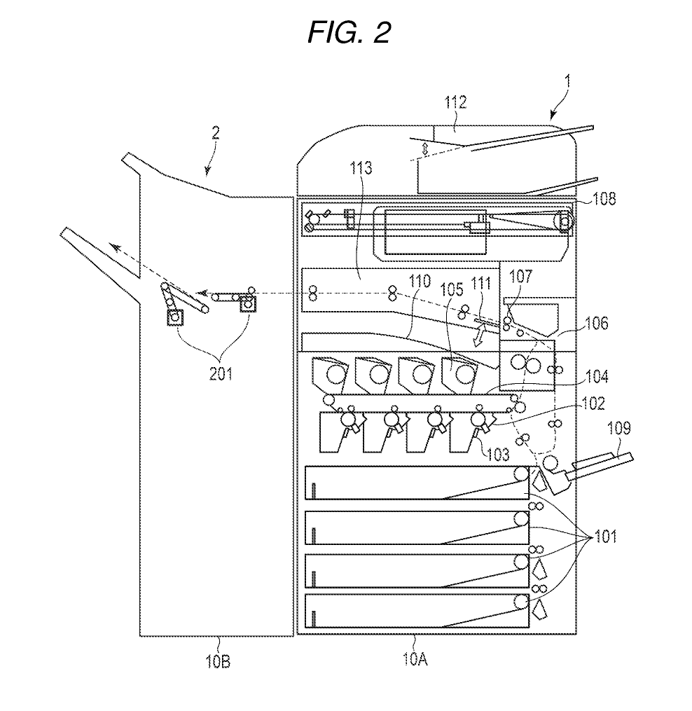

Description will be made on an image forming apparatus and a finisher according to a first exemplary embodiment, based on FIG. 2 to FIG. 4.

FIG. 2 is a schematic diagram illustrating a configuration of main units of an image forming apparatus 1 and a finisher 2 according to the first exemplary embodiment. The finisher 2 is installed in the image forming apparatus 1. The image forming apparatus 1 and the finisher 2 are attachable and detachable.

The image forming apparatus 1 includes a case 10A, a paper feeding cassette 101, an electrification charger 102, an LED head 103, a transfer belt 104, a toner cartridge 105, a fixing device 106, a paper discharge roller 107, a scanner unit 108, a manual feed tray 109, an in-body paper discharge tray 110, a conveyance path switching gate 111, an automatic original reading device 112, and a relay unit 113.

The case 10A accommodates respective units of the image forming apparatus 1. Details for the case 10A will be described later.

The paper feeding cassette 101, the electrification charger 102, the LED head 103, the transfer belt 104, the toner cartridge 105, the fixing device 106, the paper discharge roller 107, the scanner unit 108, the manual feed tray 109, the in-body paper discharge tray 110, the conveyance path switching gate 111, the automatic original reading device 112, and the relay unit 113 may have known configuration, respectively. Accordingly, detailed description thereof will be omitted. The relay unit 113 is attachable and detachable.

The finisher 2 is, for example, an inner finisher or a saddle finisher.

The finisher 2 includes a case 10B and a driving motor 201.

The case 10B accommodates respective units of the finisher 2. The case 10B will be described later.

The driving motor 201 may have a known configuration. Accordingly, detailed description of the driving motor 201 will be omitted.

When the relay unit 113 and the finisher 2 are not installed in the image forming apparatus 1, the image forming apparatus 1 operates as, for example, in the following. That is, the image forming apparatus 1 reads image information of an original document by the scanner unit 108 using the automatic original reading device 112 and converts image information into electronic data. The image forming apparatus 1 forms an image on paper by a printer unit based on the electronic data. That is, the image forming apparatus 1 transfers a toner image formed by the transfer belt 104 on a piece of paper fed from a paper feeding cassette 101 by an electrostatic force. The image forming apparatus 1 fastens and fixes the transferred toner image to the piece of paper by applying pressure and heat by the fixing device 106. In a case of one side printing, the image forming apparatus 1 discharges a piece of paper for which a fixing process is ended to a paper discharge tray using the paper discharge roller 107. On the other hand, in a case of both-side printing, the image forming apparatus 1 conveys a piece of paper of which one side (front surface) is printed in a reverse direction, allows the piece of paper to pass through a side cover side, and turns over a paper surface. The image forming apparatus 1 prints a rear surface of the piece of paper by the printer unit, similar to the front surface. Thereafter, the image forming apparatus 1 discharges the piece of paper to the paper discharge tray, similar to the case of one side printing.

When the relay unit 113 and the finisher 2 are installed in the image forming apparatus 1, the relay unit 113 and the finisher 2 operate as, for example, in the following. That is, the image forming apparatus 1 introduces a piece of paper into the relay unit 113, instead of the paper discharge tray, after performing printing on the piece of paper, similar to the case where the relay unit 113 and the finisher 2 are not installed. The relay unit 113 conveys the introduced piece of paper and introduces the piece of paper into the finisher 2. The finisher 2 performs processing such as stapling, bending, perforating, or the like, on the introduced piece of paper. The finisher 2 includes a plurality of driving motors 201 in order to perform processing or conveying of paper.

As described above, the image forming apparatus 1 is an example of an apparatus for image formation used for image formation. The finisher 2 is a peripheral device of the image forming apparatus 1 and is used for processing accompanied by forming of an image described above. Accordingly, the finisher 2 is an example of the apparatus for image formation.

The apparatus for image formation such as the image forming apparatus 1, the finisher 2, or the like includes a plurality of movable parts as described above. Accordingly, the apparatus for image formation of the image forming apparatus 1, the finisher 2, or the like has a plurality of sound sources of an operation sound. In the sound sources, a stationary sound, an impact sound, a paper friction sound, and the like are mixed. The sounds may be varied with the lapse of time.

The sound source of a stationary sound is a fan or a motor such as the driving motor 201, or the like. The power from the motor is transmitted by a gear, a timing belt, or the like and operates respective devices. The respective devices also become sound sources of a stationary sound. The stationary sound has a certain specific frequency peak. The stationary sound has a peak frequency and thus, frequently offends user's ears.

Sound sources of an impact sound include a collision sound when a piece of paper is conveyed, a sound generated by a clutch, a sound generated by a solenoid, or the like.

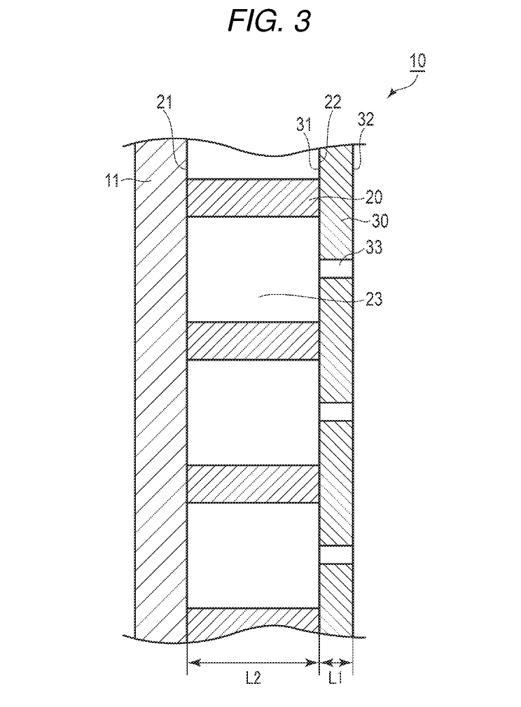

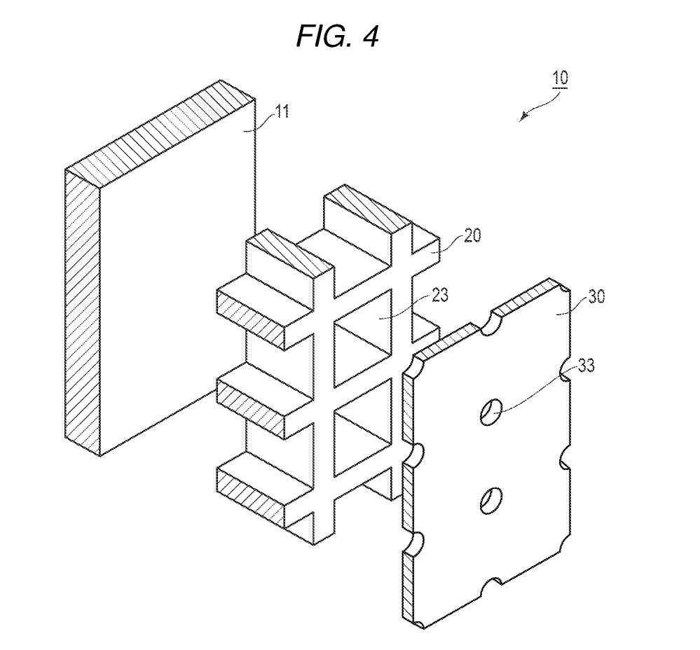

The case 10A and the case 10B (in the following, collectively referred to as “case 10”), as illustrated in FIG. 3 and FIG. 4, include a case base 11, a first member 20 provided on an inside surface of the case base 11, and a second member 30 provided on an inside surface of the first member 20 in order to reduce such a sound. FIG. 3 illustrates a schematic cross sectional view of the case 10 according to the first exemplary embodiment. FIG. 4 illustrates an exploded perspective view of the case 10 according to the first exemplary embodiment.

The case base 11 accommodates respective units of the image forming apparatus 1 or the finisher 2 in a portion which functions as a main body of the case 10.

The first member 20 has plate-like shape in which an outside surface 21 and an inside surface 22 are parallel to each other. The outside surface 21 is an example of a first surface. The inside surface 22 is an example of a second surface. The first member 20 includes a plurality of square columnar holes 23 each of which penetrating from the outside surface 21 to the inside surface 22 of the first member 20, that is, the plurality of holes 23 formed by opening the outside surface 21 side and the inside surface 22 side. It is preferable that all of the plurality of holes 23 have the same volume, respectively. The first member 20 is formed in a state where the hole 23 is provided. Otherwise, after the first member 20 is formed in a state where the hole 23 is not provided, the hole 23 is formed in the first member 20. The hole 23 is formed by using, for example, a drill, a laser processing machine, or the like.

The first member 20 is stacked on the case base 11 so that a wall surface of the inside of the case base 11, that is, a side in which respective units of an apparatus, which is a sound generation source are accommodated, is in contact with the outside surface 21 side of the first member 20. The wall surface includes surfaces of a floor side or a ceiling side as well as side surfaces.

The case base 11 and the first member 20 are joined by, for example, adhesive or welding. Otherwise, the case base 11 and the first member 20 are formed as an integrated body. When the case base 11 and the first member 20 are formed as an integrated body, the first member 20 is formed as, for example, a rib of the case base 11. In this case, a known method for forming a rib, such as an integrally molding method, can be used. From the reason that components are formed as an integrated body to thereby make it possible to reduce the number of manufacturing processes, it is possible to reduce a manufacturing cost or the like. It is preferable that material of the case base 11 is the same as that of the first member 20. When material of the case base 11 is the same as that of the first member 20, it is possible to reduce the manufacturing cost or the like.

The second member 30 has the plate-like shape in which the outside surface 31 and the inside surface 32 are parallel to each other. The outside surface 31 is an example of a third surface. The inside surface 32 is an example of a fourth surface. The second member 30 includes a plurality of columnar communicating holes 33 each of which penetrating from the outside surface 31 to the inside surface 32 of the second member 30, that is, the plurality of communicating holes 33 formed by opening the outside surface 31 and the inside surface 32. It is preferable that areas of the opening parts of the plurality of communicating holes 33 are inconsistent. As will be described later, frequencies of sounds capable of being reduced are different according to areas of opening parts. Accordingly, the communicating holes 33 having various areas of the opening parts may exist to thereby make it possible to reduce sounds of various frequencies. It is preferable that a lot of communicating holes 33 having areas of the opening parts according to frequencies of sounds are arranged in the vicinity of a sound source which generates the sound intended to be reduced. Thus, it is possible to suitably reduce the sound intended to be reduced. The second member 30 is formed in a state where the communicating hole 33 is provided. Otherwise, after the second member 30 is formed in a state where the communicating hole 33 is not provided, the communicating hole 33 is formed in the second member 30. The communicating hole 33 is formed by using, for example, a drill, a laser processing machine, or the like.

The second member 30 is stacked on the first member 20 so that the inside surface 22 side of the first member 20 is in contact with the outside surface 31 side of the second member 30. In this case, the second members 30 are stacked so that respective holes 23 and respective communicating holes 33 are connected in a one-to-one relationship. Also, in this case, it is preferable that the second members 30 are stacked so that a center of the inside surface 22 of each hole 23 coincides with a center of the outside surface 31 of each communicating hole 33. Here, the center is, for example, the center of gravity.

Although material of the second member 30 is not particularly limited as long as the material is available for forming the communicating hole 33, sound absorbing material, for example, urethane, glass wool, felt, wool, or chemical fiber such as acetate or polyamide is preferable. Sound absorbing performance of the case 10 is improved by using sound absorbing material.

The first member 20 and the second member 30 as described above may be provided throughout the inner wall surface of the case base 11 and may be provided in a portion of the inner wall surface of the case 10. When the first member 20 and the second member 30 are provided in a portion of the inner wall surface of the case 10, it is preferable that the first member 20 and the second member 30 are provided at a side on which an operator of the image forming apparatus 1 or the finisher 2 stands when conducting an operation. That is, for example, it is preferable that the first member 20 and the second member 30 are provided in a surface of a side on which an operation panel or the like is provided. When the first member 20 and the second member 30 are provided in a portion of the inner wall surface of the case 10, it is preferable that the first member 20 and the second member 30 are provided in the vicinity of a sound generation source.

### Second Exemplary Embodiment

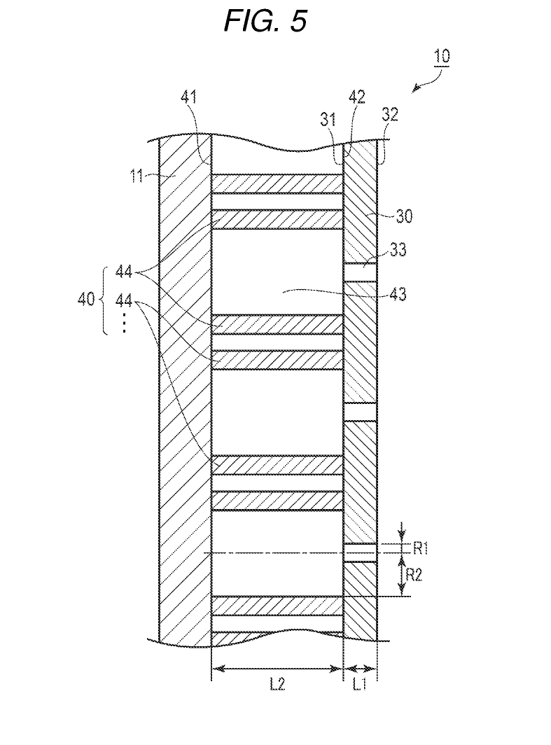

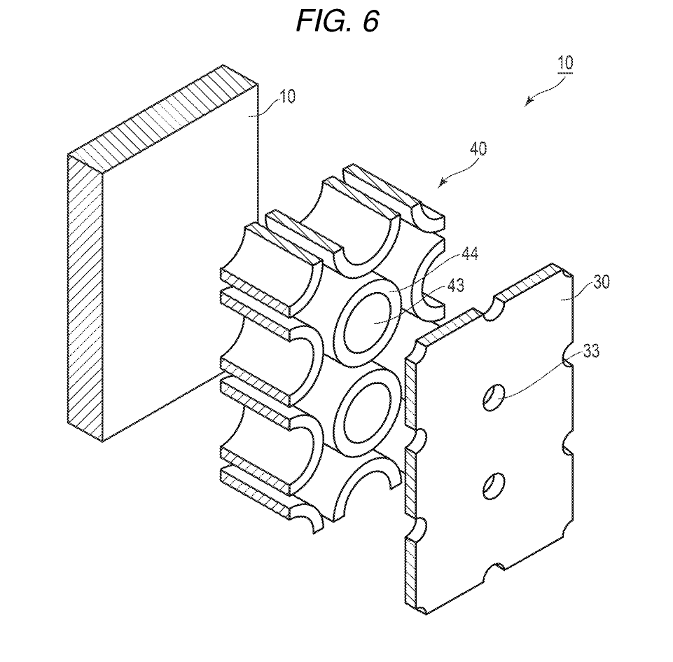

Description will be made on an image forming apparatus and a finisher according to a second exemplary embodiment based on FIG. 2, FIG. 5 and FIG. 6.

A configuration of main units of the image forming apparatus 1 and the finisher 2 according to the second exemplary embodiment is the same as that of FIG. 2 according to the first exemplary embodiment and thus, description thereof will be omitted.

In the case 10 according to the second exemplary embodiment, the first member 40 is provided instead of the first member 20, as illustrated in FIG. 5 and FIG. 6. FIG. 5 illustrates a schematic cross sectional view of the case 10 according to the second exemplary embodiment. FIG. 6 illustrates an exploded perspective view of the case 10 according to the second exemplary embodiment. The first member 40 has a plate-like shape in which an outside surface 41 and an inside surface 42 are parallel to each other. The outside surface 41 is an example of the first surface. The inside surface 42 is an example of the second surface. The first member 40 includes a plurality of members 44. Each member 44 includes a columnar hole 43 which penetrates from the outside surface 41 to the inside surface 42, that is, the columnar hole 43 formed by opening the outside surface 41 side and the inside surface 42 side. It is preferable that all of the plurality of holes 43 provided in the plurality of members 44 have the same volume, respectively. The first member 40 is formed in a state where the hole 43 is provided. Otherwise, after the first member 40 is formed in a state where the hole 43 is not provided, the hole 43 is formed in the first member 40. The hole 43 is formed by using, for example, a drill, a laser processing machine, or the like.

The first member 40 is stacked on the case base 11 so that the inside of the case base 11 is in contact with the outside surface 41 side of the first member 40.

It is preferable that the case base 11 and the first member 40 are formed as an integrated body, similar to the case of the first member 20.

The second member 30 has the configuration similar to that of the first exemplary embodiment.

Similarly as in the first exemplary embodiment, the second member 30 is stacked on the first member 40 so that the inside surface 42 side of the first member 40 is in contact with the outside surface 31 side of the second member 30. In this case, the second members 30 are stacked so that respective holes 43 and respective communicating holes 33 are connected in a one-to-one relationship. Also, in this case, it is preferable that the second members 30 are stacked so that a center of the inside surface 42 of each hole 43 coincides with a center of the outside surface 31 of each communicating hole 33.

As in the first exemplary embodiment and the second exemplary embodiment, the hole 23 or the hole 43 and the communicating hole 33 are connected to thereby form a space in which the inside surface 42 is opened. In the space, a sound of a fixed frequency (in the following, referred to as “resonance frequency”) is resonated so as to convert the sound into thermal energy. With this, loudness is reduced. That is, the same effect as that of a Helmholtz resonator is exhibited in the space.

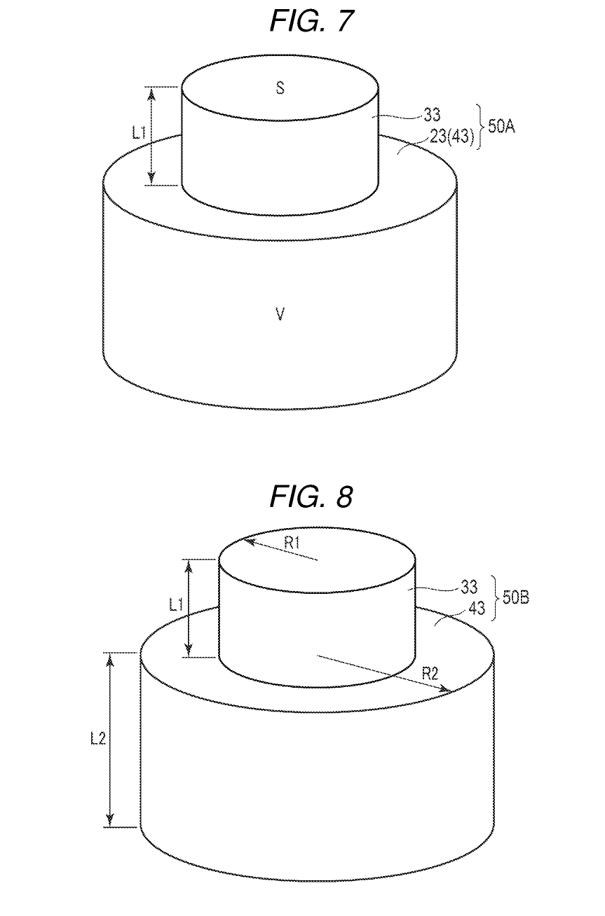

FIG. 7 illustrates a schematic diagram of a space 50A formed by the hole 23 or the hole 43 and the communicating hole 33. When it is assumed that a volume of the hole 23 or the hole 43 is V [m³], an area of an opening part of the communicating hole 33 is S [m²], a length (thickness of second member 30) of the communicating hole 33 is L1 [m], and a speed of sound is c [m/s], a resonance frequency f [Hz] at which a sound is absorbed in the space 50A is represented by the following Equation (1).

$$f = {\frac{c}{2 π} [ S / ( V \cdot L 1 ) ]}^{1 / 2} [ Hz ] \qquad ( 1 )$$

FIG. 8 illustrates a schematic diagram of a space 50B formed by the hole 43 and the communicating hole 33. When a communicating hole included in the second member has a columnar shape like the communicating hole 33 and a hole included in the first member has a columnar shape like the hole 43, the resonance frequency f may also be represented as in the following. That is, when it is assumed that a radius of an opening part of the communicating hole 33 is R1 [m], a radius of an opening part of the hole 43 is R2 [m], an area of an opening part of the communicating hole 33 is S [m²], and a length (thickness of first member 40) of the hole 43 is L2 [m], a resonance frequency f [Hz] at which a sound is absorbed in the space 50B is represented by the following Equation (2).

$$f = {\frac{c}{2 π} [ R {1}^{2} / ( R {2}^{2} \cdot L 1 \cdot L 2 ) ]}^{1 / 2} [ Hz ] \qquad ( 2 )$$

According to an equal loudness curve, human audible sense has high sensitivity to a sound having a frequency 2000 Hz to 5000 Hz. Accordingly, it is preferable that the resonance frequency f [Hz] is 2000 Hz to 5000 Hz. When the Equation (1) is modified, the following Equation (3) is obtained.

$$S = {[ f \cdot \frac{2 π}{c} ]}^{2} \cdot V \cdot L 1 [ {m}^{2} ] \qquad ( 3 )$$

Accordingly, when it is intended to set the resonance frequency f [Hz] to be in a range of 2000 Hz to 5000 Hz, the area of the opening part 5 [m²] of the communicating hole 33 may be set so as to be within a range illustrated in the following Equation (4).

$${[ \frac{4000 π}{c} ]}^{2} \cdot V \cdot L 1 < S < {[ \frac{10000 π}{c} ]}^{2} \cdot V \cdot L 1 \qquad ( 4 )$$

When a hole included in the first member has a columnar shape and a communicating hole included in the second member has a columnar shape, the resonance frequency f may also be represented as in the following. That is, when the Equation (2) is modified, the following Equation (5) is obtained.

R1=[(f·2π/c)²·R2²·L1·L2]^{1/2} [m] (5)

Accordingly, when it is intended to set the resonance frequency f[Hz] to be in a range of 2000 Hz to 5000 Hz, the radius R1 [m²] of the opening part of the communicating hole 33 may be set so as to be within a range illustrated in the following Equation (6).

$${[ {[ \frac{4000 π}{c} ]}^{2} \cdot R {2}^{2} \cdot L 1 \cdot L 2 ]}^{1 / 2} < R 1 < {[ {[ \frac{10000 π}{c} ]}^{2} \cdot R {2}^{2} \cdot L 1 \cdot L 2 ]}^{1 / 2} \qquad ( 6 )$$

As represented in the Equation (4) or Equation (6), for the case 10 of the exemplary embodiment, it is possible to change the resonance frequency f by only changing the area S of the opening part or the radius R1 of the opening part of the communicating hole 33. Accordingly, the case 10 of the exemplary embodiment is able to be adapted to make sounds of various frequencies silent with a simple modification of the case 10 and thus, a type of sound absorbing material does not need to be changed according to a kind of the apparatus unlike when only the sound absorbing material is used.

The first exemplary embodiment and the second exemplary embodiment may also be modified as in the following.

The first member 20 or the first member 40 may also include a hole formed by opening only the inside surface and not opening the outside surface, instead of the hole 23 or the hole 43. In this case, it is needless to say that a height of the hole is not coincident with a thickness of the first member.

The first member 20 or the first member 40 and the second member 30 may also be formed as an integrated body. The case base 11, the first member 20 or the first member 40, and the second member 30 may also be formed as an integrated body.

After the first member 20, the first member 40, or the second member 30 is formed by being divided into two or more parts, the first member 20, the first member 40, or the second member 30 may be formed by combining the parts. In this case, only some of the parts of the first member 20 or the first member 40 and the case base 11 or the second member 30 may be formed as an integrated body. Furthermore, only some of the parts of the second member 30 and the first member 20 or the first member 40 may also be formed as an integrated body.

In the first exemplary embodiment and the second exemplary embodiment, the hole 23 has a square columnar shape and the hole 43 has a columnar shape. However, the shape of the hole is not limited to the square column shape or a columnar body shape and may also have other columnar body shapes, for example, a triangular columnar shape, a hexagonal columnar shape or an elliptic columnar shape. Otherwise, the shape of the hole is not limited to the columnar body shape and may also have, for example, a truncated pyramid shape, a trumpet shape, a spherical shape, or the bell shape.

In the first exemplary embodiment and the second exemplary embodiment, the communicating hole 33 has a columnar shape. However, the shape of the communicating hole is not limited to a columnar shape and may also have other columnar body shapes, for example, a triangular columnar shape, a hexagonal columnar shape or an elliptic column shape. Otherwise, the shape of the communicating hole is not limited to a columnar body shape and may also have, for example, a truncated pyramid shape.

In the first exemplary embodiment, the outside surface 21 and the inside surface 22 of the first member 20 are parallel to each other. However, the outside surface 21 and the inside surface 22 may not be parallel to each other. In the second exemplary embodiment, the outside surface 41 and the inside surface 42 of the first member 40 are parallel to each other. However, the outside surface 41 and the inside surface 42 may not be parallel to each other.

In the first exemplary embodiment and the second exemplary embodiment, the outside surface 31 and the inside surface 32 of the second member 30 are parallel to each other. However, the outside surface 31 and the inside surface 32 may not be parallel to each other.

In the first exemplary embodiment and the second exemplary embodiment, the space 50A or the space 50B is arranged in an orthogonal lattice shape. However, the space 50A or the space 50B may also be arranged in a diagonally crossing lattice shape. Otherwise, the space 50A or the space 50B may also be irregularly arranged.

In the first exemplary embodiment and the second exemplary embodiment, the case 10 is included in the image forming apparatus 1 or the finisher 2. However, the case of the exemplary embodiment may also be included in another apparatus provided with a movable part. The case of the exemplary embodiment may also accommodate the entirety of the apparatus and only a portion of the apparatus.

### EXAMPLE

The best mode of the exemplary embodiment will be described using examples and comparative examples. The examples and comparative examples do not limit a range of the exemplary embodiment.

### Example 1

A first member of the example 1 was formed to have a rectangular shape of which a length and a width of each of opening parts of an inside surface side and an outside surface side of a hole were set as 0.0603 [m] and 0.05 [m], respectively. That is, a shape of the hole is a square columnar shape. In the first member of the example 1, a height (thickness of first member) of the hole was set as 0.01 [m]. In a second member of the example 1, a length (thickness of second member) of a communicating hole was set as 0.01 [m] and a radius of the communicating hole was set as 0.0071 [m]. Polycarbonate was used as material of the second member of the example 1. From the conditions described above, when the temperature is 25° C., the resonance frequency f is 1265 Hz by the Equation (1). Regarding the case for measurement having the configuration as described above, a sound pressure level when a motor sound of 1265 Hz is generated in the environmental temperature 25° C. was measured. The results are listed in the Table 1.

### Comparative Example 1

Regarding a case for measurement having the same configuration as that of the example 1 except that the second member is not provided, the sound pressure level was measured, similarly as in the example 1. The results are listed in the Table 1.

### Example 2

Regarding a case for measurement having the same configuration as that of the example 1 except that urethane which is sound absorbing material is used as material of the second member, the sound pressure level was measured, similarly as in the example 1. The results are listed in the Table 1.

### Comparative Example 2

Regarding a case for measurement having the same configuration as that of the example 2 except that the second member does not include the communicating hole, the sound pressure level was measured, similarly as in the example 1. The results are listed in the Table 1.

TABLE 1

| | | | | Sound |
|---|---|---|---|---|
| | | | | pressure |
| | Second | Communi- | Material of | level |
| | member | cating hole | second member | [dBA] |
| Example 1 | Provided | Existence | Polycarbonate | 38.2 |
| Comparative | Not provided | — | — | 39.1 |
| example 1 | | | | |
| Example 2 | Provided | Existence | Sound absorbing | 37.9 |
| | | | material (urethane) | |
| Comparative | Provided | Non- | Sound absorbing | 38.6 |
| example 2 | | existence | material (urethane) | |

From the example 1 and the comparative example 1 of the Table 1, it is understood that the sound pressure level was reduced in the case provided with the second member, which includes the communicating hole, than in the case not provided with the second member. From the example 2 and the comparative example 2 of the Table 1, it is understood that the sound pressure level was reduced in the case of which the second member includes the communicating hole than in the case of which the second member does not include the communicating hole. Furthermore, from the example 1 and the example 2 of the Table 1, it is understood that the sound pressure level was reduced in the case of which material of the second member is sound absorbing material than in the case of which material of the second member is not sound absorbing material.

### Example 3

A first member of the example 3 was formed to have a circular shape in which a radius of opening parts of an inside surface side and an outside surface side of a hole were set as 0.01 [m]. That is, a shape of the hole is a columnar shape. In the first member of the example 3, a height (thickness of first member) of the hole was set as 0.01 [m]. In a second member of the example 3, a length (thickness of second member) of a communicating hole was set as 0.01 [m]. Furthermore, the communicating holes having various sizes were provided in the second member of the example 3. The radius of the communicating hole is sectioned into 0.0005 [m] in a range from 0.0035 [m] to 0.0095 [m]. In the range from 0.0035 [m] to 0.0095 [m], the resonance frequencies f[Hz] for respective radii when a speed of sound is 346.7 [m/s] are listed in the Table 2. As illustrated in the Table 2, the resonance frequencies f[Hz] are within the range of approximately 2000 Hz to approximately 5000 Hz.

TABLE 2

| R1[m] | f[Hz] |
|---|---|
| 0.0035 | 1932 |
| 0.004 | 2208 |
| 0.0045 | 2484 |
| 0.005 | 2760 |
| 0.0055 | 3036 |
| 0.006 | 3312 |
| 0.0065 | 3588 |
| 0.007 | 3864 |
| 0.0075 | 4141 |
| 0.008 | 4417 |
| 0.0085 | 4693 |
| 0.009 | 4969 |
| 0.0095 | 5245 |

Regarding the image forming apparatus which includes the case having the configuration as described above, three subjects of a subject a to a subject c gave points using a five-grade evaluation of a very noisy (1 point), noisy (2 point), cannot say (3 point), quiet (4 point), and very quiet (5 point). The results of the evaluation and average points are listed in Table 3.

### Comparative Example 3

Regarding the image forming apparatus which is the same as in the example 3 except that the second member is not provided, the evaluation is made similarly as in the example 3. The results of the evaluation and average points are listed in Table 3.

TABLE 3

| | Subject a | Subject b | Subject c | Average point |
|---|---|---|---|---|
| Example 3 | 3 | 4 | 3 | 3.3 |
| Comparative | 2 | 2 | 2 | 2.0 |
| example 3 | | | | |

From the Table 3, it is understood that the second members of which the sizes of the communicating holes are variously changed are used to thereby make it possible to make an apparatus such as an image forming apparatus including a plurality of sound sources of an operation sound silent.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the spirit of the inventions. The accompanying claims and their equivalents are intended to cover such forms or modifications as would fall within the scope and spirit of the inventions.

What is claimed is:

1. A case for accommodating an apparatus including a movable part, comprising:
a case base;
a first member having a first surface and a second surface opposing each other and provided with a hole formed by opening at least a side of the second surface, among a side of the first surface and the side of the second surface; and
a second member having a third surface and a fourth surface opposing each other and provided with a communicating hole formed by opening both a side of the third surface and a side of the fourth surface,
the first member configured such that the first surface is in contact with a wall surface of a side of the case base,
the second member configured such that the third surface is in contact with the second surface of the first member, and
the hole and the communicating hole connected to each other.

2. The case according to claim 1,
wherein the second member comprises a sound absorbing material.

3. The case according to claim 2,
wherein the sound absorbing material comprises at least one of urethane, glass wool, felt, wool, or chemical fiber such as acetate or polyamide.

4. The case according to claim 1,
wherein when it is assumed that an area of an opening part of the communicating hole is S [m²], a length of the communicating hole is L1 [m], a volume of the hole is V[m³], and a speed of a sound is c [m/s], an area of the opening part of the communicating hole is in a range represented by Equation (A):
$${[ \frac{4000 π}{c} ]}^{2} \cdot V \cdot L 1 < S < {[ \frac{10000 π}{c} ]}^{2} \cdot V \cdot L 1. \qquad ( A )$$

5. The case according to claim 1,
wherein the wall surface and the first member are formed as an integrated body.

6. The case according to claim 1,
wherein the wall surface and the first member are joined by an adhesive or welding.

7. The case according to claim 1,
wherein the first member has a plate-like shape with an outside surface and an inside surface parallel to each other.

8. The case according to claim 1,
wherein the second member has a plate-like shape with an outside surface and an inside surface parallel to each other.

9. The case according to claim 1,
wherein the first member has a plurality of holes and the second member has a plurality of communicating holes.

10. The case according to claim 9,
wherein the first member has a number of holes and the second member has the same number of communicating holes.

11. The case according to claim 1,
wherein the case base and the first member comprise the same material.

12. An image forming apparatus, comprising:
a case comprising:
a case base;
a first member having a first surface and a second surface opposing each other and provided with a hole formed by opening at least a side of the second surface, among a side of the first surface and the side of the second surface; and
a second member having a third surface and a fourth surface opposing each other and provided with a communicating hole formed by opening both a side of the third surface and a side of the fourth surface,
the first member configured such that the first surface is in contact with a wall surface of a side of the case base,
the second member configured such that the third surface is in contact with the second surface of the first member, and
the hole and the communicating hole connected to each other; and
an image forming section at least partially within the case.

13. The image forming apparatus according to claim 12,
wherein the second member comprises a sound absorbing material.

14. The image forming apparatus according to claim 12,
wherein when it is assumed that an area of an opening part of the communicating hole is S[m²], a length of the communicating hole is L1 [m], a volume of the hole is V[m³], and a speed of a sound is c[m/s], an area of the opening part of the communicating hole is in a range represented by Equation (A):
$${[ \frac{4000 π}{c} ]}^{2} \cdot V \cdot L 1 < S < {[ \frac{10000 π}{c} ]}^{2} \cdot V \cdot L 1. \qquad ( A )$$

15. The image forming apparatus according to claim 12,
wherein the wall surface and the first member are formed as an integrated body.

16. The image forming apparatus according to claim 12,
wherein the first member has a plate-like shape with an outside surface and an inside surface parallel to each other.

17. The image forming apparatus according to claim 12,
wherein the second member has a plate-like shape with an outside surface and an inside surface parallel to each other.

18. The image forming apparatus according to claim 12,
wherein the first member has a plurality of holes and the second member has a plurality of communicating holes.

19. The image forming apparatus according to claim 18,
wherein the first member has a number of holes and the second member has the same number of communicating holes.

20. The image forming apparatus according to claim 12,
wherein the case base and the first member comprise the same material.
